(19) United States
(12) Patent Application Publication
(10) Pub. No.: US 2010/0260568 A1
(43) Pub. Date: Oct. 14, 2010

(54) THREAD MILLING CUTTER

(75) Inventor: Jiro Osawa, Toyokawa-shi (JP)

Correspondence Address: OLIFF & BERRIDGE, PLC, P.O. BOX 320850, ALEXANDRIA, VA, 22320-4850, US

(73) Assignee: OSG CORPORATION, TOYOKAWA-SHI (JP)

(21) Appl. No.: 12/734,371

(22) PCT Filed: Oct. 29, 2007
(86) PCT No.: PCT/JP2007/071037

§ 371 Date: Apr. 28, 2010

(51) Int. Cl. B23G 5/18; B23C 3/32

(52) U.S. Cl. 409/74; 407/24

(57) ABSTRACT

As shown in a development view of FIG. 2, spiral flutes 16a and 16c have a lead angle α different from a lead angle β of spiral flutes 16b and 16d adjacently placed circumferentially to allow the lead angle β of cutting edges 20a and 20c, formed along the spiral flutes 16a and 16c, respectively, to be different from the lead angle α of cutting edges 20b and 20d adjacently placed circumferentially. This causes the cutting edges 20a to 20d to have intervals that axially vary in series such that the cutting edges 20a to 20d have unequal intervals. This results in irregular increase or decrease in milling resistance encountered during milling of a thread, thereby suppressing the occurrence of chatter vibration due to resonance with a capability of milling the thread with excellent milling precision under various milling conditions.

### TECHNICAL FIELD

The present invention relates to thread milling cutters and, more particularly, to a thread milling cutter configured to suppress chatter vibration of a cutting tool with excellent milling precision.

### BACKGROUND OF THE INVENTION

There has been known a thread milling cutter having an outer circumferential periphery formed with multiple non-lead convex ridges that are axially spaced with a fixed pitch. Plural flutes are formed intersecting with the convex ridges into plural segmented lands. Cutting edges are formed along the flutes at circumferentially leading faces thereof, respectively (see Patent Publication 1). The thread milling cutter of such a structure is fixedly attached to an NC machining center, by which the thread milling cutter is drivably rotated about its center axis and axially lead fed to a thread milling material while relatively kept in an orbital motion with respect thereto. This makes it possible to use a single cutting tool for milling various external threads and internal threads different in diameter dimension having flute cross-sections associated with the convex ridges.

Patent Publication 1: Japanese Patent Application Publication No. 9-192930

### DISCLOSURE OF THE INVENTION

### Problems to be Solved by the Invention

With the structure of such a related art, however, the thread milling cutter has the plural cutting edges, formed with fixed leads equal to each other, which are equidistantly provided circumferentially of the tool. When milling a thread, milling resistance is caused to increase or decrease at a fixed frequency with the resultant occurrence of vibration, which in turn is amplified due to resonance causing chatter vibration to occur. This results in the formation of the thread having flanks with wavy uneven surfaces, causing a risk of deterioration in milling precision with the occurrence of abnormal noise. Thus, milling conditions has been forced to degrade with a view to avoiding the occurrence of such chatter vibration.

The present invention has been completed with the above view in mind and has an object to provide a cutting tool suppressed in chatter vibration under various milling conditions to enable the cutting of a thread with excellent milling precision.

### Means for Solving the Problems

The object indicated above is achieved in the first mode of the present invention, which provides a thread milling cutter having an outer circumferential periphery, formed with multiple non-lead convex ridges, which have cross-sectional shapes, respectively, each in conformity to a thread groove of a targeted internal thread, with a fixed pitch in an axial direction of the thread milling cutter, and plural flutes intersecting with the convex ridges to define plural segmented lands circumferentially formed with plural cutting edges facing the flutes, respectively, wherein: the plural cutting edges spirally extend in a same direction circumferentially or extend in parallel to the center axis, and have fixed leads, respectively, in which the lead of at least one of the cutting edges is made different from the lead of another cutting edge adjacently placed circumferentially such that the cutting edges are spaced circumferentially at intervals that in series vary in an axial direction. The aforementioned “lead” means the distance in the axial direction that such as the cutting edge forwards by one rotation circumferentially.

The object indicated above is achieved in the second mode of the present invention, which provides a thread milling cutter having an outer circumferential periphery, formed with multiple non-lead convex ridges, which have cross-sectional shapes, respectively, each in conformity to a thread groove of a targeted internal thread, with a fixed pitch in an axial direction of the thread milling cutter, and plural flutes intersecting with the convex ridges to define plural segmented lands circumferentially formed with plural cutting edges facing the flutes, respectively, wherein: the plural cutting edges spirally extend in a same direction circumferentially or extend in parallel to the center axis, and have equal intervals circumferentially in a predetermined intermediate position of a thread milling portion, formed with the plural cutting edges, along an axial direction thereof, but have unequal intervals in other areas deviated from the intermediate position toward front and rear ends of the thread milling portion.

The object indicated above is achieved in the third mode of the present invention, which provides the thread milling cutter according to the second mode of the invention, wherein the plural cutting edges have fixed leads, respectively, in which the lead of at least one of the cutting edges is made different from the lead of another cutting edge neighboring circumferentially to allow the cutting edges to have intervals circumferentially that symmetrically with respect to a centerline of the spiral flute and smoothly increase or decrease as the cutting edges extend from the intermediate position toward a front end and a rear end of the thread milling portion.

The object indicated above is achieved in the fourth mode of the present invention, which provides the thread milling cutter according to the third mode of the invention, wherein the plural flutes have fixed width dimensions with fixed leads, respectively, in which the lead of at least one of the plural flutes is made different from the lead of another plural flute adjacently placed circumferentially such that the lead of one cutting edge formed facing the one flute, is made different from the lead of the another cutting edge adjacently placed circumferentially.

The object indicated above is achieved in the fifth mode of the present invention, which provides the thread milling cutter according to the third mode of the invention, wherein the plural flutes are formed with fixed leads equal to each other in which at least one of the plural flutes has a width dimension that linearly increases or decreases such that the lead of one cutting edge formed facing the one flute, is made different from the lead of another cutting edge adjacently placed circumferentially.

The object indicated above is achieved in the sixth mode of the present invention, which provides the thread milling cutter according to any one of the first to fifth modes of the invention, wherein the plural cutting edges include even numbers of cutting edges that are alternately formed with two different kinds of leads.

The object indicated above is achieved in the seventh mode of the present invention, which provides the 7. The thread milling cutter according to any one of the first to sixth modes of the invention, wherein the plural cutting edges are formed with two kinds of leads including L1 and L2, in which the smaller lead L2 is set to lie in a value ranging from 0.7×L1 to 0.95×L1.

The object indicated above is achieved in the eighth mode of the present invention, which provides the thread milling cutter according to any one of the first to seventh modes of the invention, wherein the plural cutting edges are spaced circumferentially at equal intervals in a central area, in which the plural cutting edges are formed, of the thread milling portion in the axial direction thereof.

### Advantageous Effect of the Invention

According to the first mode of the present invention, the plural cutting edges are formed with the fixed lead. The lead of at least one of the cutting edges is made different from the lead of the cutting edges adjacently placed circumferentially. The intervals of the cutting edges are caused to in series vary in the axial direction, so that the intervals, associated with the cutting edges, remain unequal. This allows a thread to be milled with milling resistance varying in irregular increase or decrease, thereby suppressing the occurrence of chatter vibration. Thus, the thread can be cut with excellent milling precision under various milling conditions. With the provision of the plural cutting edges formed with the leads all of which are fixed, the cutting edges of such configuration can be easily formed with increased precision.

According to the second mode of the present invention, the plural cutting edges are spaced at the equal intervals in a predetermined intermediate position of the thread milling portion in the axial direction thereof, whereas in the other areas deviated from the intermediate position to be closer to the front and rear ends of the thread milling portion, the cutting edges are spaced at the unequal intervals. This enables the thread to be milled with a vicinity of the intermediate position being involved. This alleviates unbalanced load that would act on the thread milling portion at fore and aft parts of the intermediate position in the axial direction, thereby making it possible to stably mill the thread with a center on the intermediate position. Combined with the unequal intervals of the cutting edges formed on both sides of the intermediate position, chatter vibration can be further effectively suppressed and, therefore, the thread can be milled with excellent milling precision under various milling conditions.

According to the third mode of the present invention, the plural cutting edges have fixed leads, respectively, in which the lead of at least one of the cutting edges is made different from the lead of another cutting edge neighboring circumferentially to allow the cutting edges to have intervals that symmetrically with respect to the centerline of the spiral flute and increase or decrease as the cutting edges extend from the intermediate position toward a front end and a rear end of the thread milling portion. Thus, the thread can be further stably milled with a center on the intermediate position. In addition, with the cutting edges having the leads both of which are fixed, the cutting edges can be easily formed with increased precision.

According to the fourth mode of the present invention, the plural flutes have fixed width dimensions with fixed leads, in which the lead of at least one of the plural flutes is made different from the lead of another plural flute adjacently placed circumferentially such that the lead of one cutting edge formed facing the one flute, is made different from the lead of the another cutting edge adjacently placed circumferentially. When lead feeding a tool raw material for grinding, for instance, the flutes, merely varying the leads of the flutes, upon varying a rotational speed or a feed speed, enables the cutting edges to be easily formed with predetermined leads with high precision at low cost.

According to the fifth mode of the present invention, the plural flutes are formed with fixed leads equal to each other in which at least one of the plural flutes has a width dimension that linearly increases or decreases such that the lead of one cutting edge formed facing the one flute, is made different from the lead of another cutting edge adjacently placed circumferentially. Upon merely adjusting the grinding wheel in attitude for grinding, for instance, the flute to in series vary the width dimension thereof, the cutting edges can be easily formed with predetermined leads with high precision at low cost.

According to the sixth mode of the present invention, the plural cutting edges include even numbers of cutting edges that are alternately formed with two different kinds of leads. This effectively suppresses the occurrence of chatter vibration due to cyclic change of milling resistance in a greater effect than that achieved when merely varying one lead of the cutting edges of the thread milling cutter having four or more cutting edges.

According to the seventh mode of the present invention, the plural cutting edges are formed with two kinds of leads including L1 and L2, in which the smaller lead L2 is set to lie in a value ranging from 0.7×L1 to 0.95×L1 to be less than 95% of the lead L1. This allows the unequal intervals of the cutting edges, resulting from a difference in leads, to have a stable effect of suppressing the occurrence of chatter vibration. With the lead L2 having a value greater than 70% of the lead L1, moreover, it becomes possible for the thread milling portion to ensure a predetermined axial length for milling the thread without causing the adjacent cutting edges not to intersect each other on the thread milling cutter having the four cutting edges.

According to the eighth mode of the present invention, the plural cutting edges are spaced at equal intervals in a central area of the thread milling portion in the axial direction thereof. In general practice, the thread can be milled with the central area of the thread milling portion being involved. Therefore, it becomes possible to have a stable effect of suppressing the occurrences of unbalanced load and chatter vibration with improved milling precision without making a conscious determination to prepare a particular area for the thread milling portion to be involved for the cutting.

### BRIEF DESCRIPTION OF THE DRAWINGS

FIGS. 1(a) to (d) are views showing a thread milling cutter of one embodiment according to the present invention with FIG. 1(a) representing a front view; FIG. 1(b) representing an enlarged bottom view; FIG. 1(c) representing an enlarged cross-sectional view taken on line IC-IC of FIG. 1(a); and FIG. 1(d) representing an enlarged cross-sectional view taken on line ID-ID of FIG. 1(a).

FIG. 2 is a view showing the thread milling cutter of FIG. 1 having an outer circumferential periphery formed with a thread milling portion having spiral flutes, lands and cutting edges that are shown in a planar development circumferentially S.

FIGS. 3(a) to 3(f) are views illustrating one example of a sequence of cutting an internal thread with the use of the thread milling cutter shown in FIG. 1.

FIGS. 4(a) and 4(b) are views showing variations of resultant forces in comparison which are obtained by measuring milling resistances in an xyz-direction during operations to cut internal threads upon using an inventive product (with an unequal lead) and a comparative product (with an equal lead).

FIGS. 5(a) and 5(b) are views showing variations of resultant forces in comparison with milling resistances oriented in an xy-direction during the same thread-cutting operation as that of FIG. 4.

FIGS. 6(a) and 6(b) are views showing variations of resultant forces in comparison with milling resistances oriented in a z-direction during the same thread-cutting operation as that shown in FIG. 4.

FIGS. 7(a) to 7(c) are diagrams illustrating analyzed results on the variations in milling resistances shown in FIGS. 4 to 6.

FIG. 8 is a view showing a thread milling cutter of another embodiment according to the present invention represented in a development view, corresponding to FIG. 2, in which spiral flutes have width dimensions each linearly varying in series to allow plural cutting edges to be formed with unequal leads.

### EXPLANATION OF REFERENCES

10: thread milling cutter 14: thread milling portion 16a to 16d, 40a to 40d: spiral flutes (flutes) 18a to 18d, 42a to 42d: lands 20a to 20d, 44a to 44d: cutting edges S: center axis α,β: lead angle

### BEST MODE FOR CARRYING OUT THE INVENTION

A thread milling cutter, implementing the present invention, is fixedly attached to an NC machining center, by which the thread milling cutter is drivably rotated about its center axis and axially lead fed to a thread milling material while kept in an orbital motion with respect thereto. This enables a single cutting tool to be used for milling various external threads and internal threads that are different in diameter dimension. For milling the internal thread, a hole may be provided in the form of a blind hole with a bottom wall or a through-hole.

With the thread milling cutter, further, convex ridges may be used to mill only thread grooves in one case where an inner circumferential wall of the blind hole is left intact as crests of a thread portion of the internal thread and in another case where an outer circumferential wall of a cylindrical raw material is left intact as crests of a thread portion of the external thread. In another alternative, the thread milling cutter may include full-shaped cutting edges whose convex ridges have root portions contributing to milling work for performing milling operation with the crests of the thread portion being involved.

As plural flutes, the use may be preferably made of spiral flutes that are fluted in the same direction as the milling rotational direction as viewed from a shank. In an alternative, the spiral flutes may be configured to flute in a direction opposite to the milling rotational direction. In another alternative, the plural flutes may be formed in linear flutes that are parallel to a center axis of the shank. The linear flutes correspond to flutes with infinite leads.

According to a first aspect of the present invention, at least the cutting edges may have unequal leads with no need to have an area (an intermediate position employed in a second aspect of the present invention) at which the cutting edges are equidistantly spaced circumferentially. It doesn't matter if the cutting edges extend at unequal intervals over an entire length of a thread milling portion. In addition, with a view to allowing the lead to comply with a flute angle and a lead angle, the cutting edges may be defined in terms of the flute angle and the lead angle instead of the lead. This similarly applies to another aspect of the present invention.

According to a second aspect of the present invention, the plural cutting edges may be spaced at intervals that symmetrically with respect to the centerline of the spiral flute and smoothly increase or decrease in an axial direction of the thread milling portion with an intervening predetermined intermediate position. That is, unequal percentages of unequal intervals may be preferably caused to increase smoothly, but the intervals may be configured to increase or decrease in a non-symmetric fashion. That is, according to a third aspect of the present invention, all of the plural cutting edges are formed with fixed leads and, hence, the unequal percentages symmetrically increase in a linear fashion with the intervening intermediate position. In carrying out the second aspect of the present invention, however, the cutting edges may have the leads of: one type in which the leads are varied in the middle of the thread milling portion; or another type in which the leads are in series varied. Thus, no need arises for the unequal percentage to necessarily increase in a symmetric fashion.

Further, although the intervals of the plural cutting edges may be preferably varied on the thread milling portion over an entire area thereof, for instance, the unequal percentages of the cutting edges may be fixed, i.e., the leads of the cutting edges may be equaled in a partial area such as a nearby area of a rear end or a nearby area of a front end of the thread milling portion. Even with the first and third aspects of the present invention, no need necessarily arises for the cutting edges to have the fixed leads over the entire area of the thread milling portion. For instance, the leads may be fixed in an area within a range of, for instance, more than 90% of the thread milling portion wherein the leads may have some varying margins at the nearby area of the rear end or the nearby area of the front end of the thread milling portion. This similarly applies to the leads of the flutes in fourth and fifth aspects of the present invention.

Although the predetermined intermediate position, at which the cutting edges are spaced at the equal intervals, may preferably include a central area of the thread milling portion in the axial direction thereof like a structure of an eighth aspect of the present invention, the predetermined intermediate position may be set to a position deviated toward the front or rear ends of the thread milling portion. According to the eighth aspect of the present invention, no intention is made for the “central area” to mean only an axial middle of the thread milling portion in a geometric expression. The “central area” may be regarded to include a center area even if a deviation occurs from the middle toward the front or rear ends of the thread milling portion within a range less than 5% of the thread milling portion in the axial direction thereof.

According to a fifth aspect of the present invention, each of the flutes has a width dimension that is caused to linearly increase or decrease. Such a width dimension can be varied by in series adjusting, for instance, the attitude of the grinding wheel for the flutes to be ground. This can be accomplished in various modes including step of forming the plural flutes in partially duplicative patterns with different leads to enable the formation of the flutes with linearly varying width dimensions as a whole.

A sixth aspect of the present invention is related to a thread milling cutter having even numbers of cutting edges with leads alternately made different from each other. In implementing another aspect of the present invention, it becomes possible to adopt a thread milling cutter of an odd number of cutting edges such as three cutting edges or the like. In another alternative, the plural cutting edges may have one lead that is made different from a lead of the remaining cutting edge.

According to a seventh aspect of the present invention, a smaller lead L2 is set to lie in a value ranging from 70% to 95% of a larger lead L1. In cases where the thread milling portion has a short axial dimension or where the thread milling portion has a less number of cutting edges, it doesn't matter if the lead L2 is selected to be less than the value of 70%. In carrying out the other aspect of the present invention, the lead L2 may be possibly set to lie in a value exceeding such a range.

The thread milling cutter may be made of materials such as ceramic carbide tool materials including high-speed tool steel and cemented carbide or the like. The thread milling cutter may preferably have the thread milling portion with the cutting edges applied with hard coating of TiAlN or the like depending on needs.

### Embodiment

Hereunder, various embodiments of the present invention will be described below in detail with reference to the accompanying drawings.

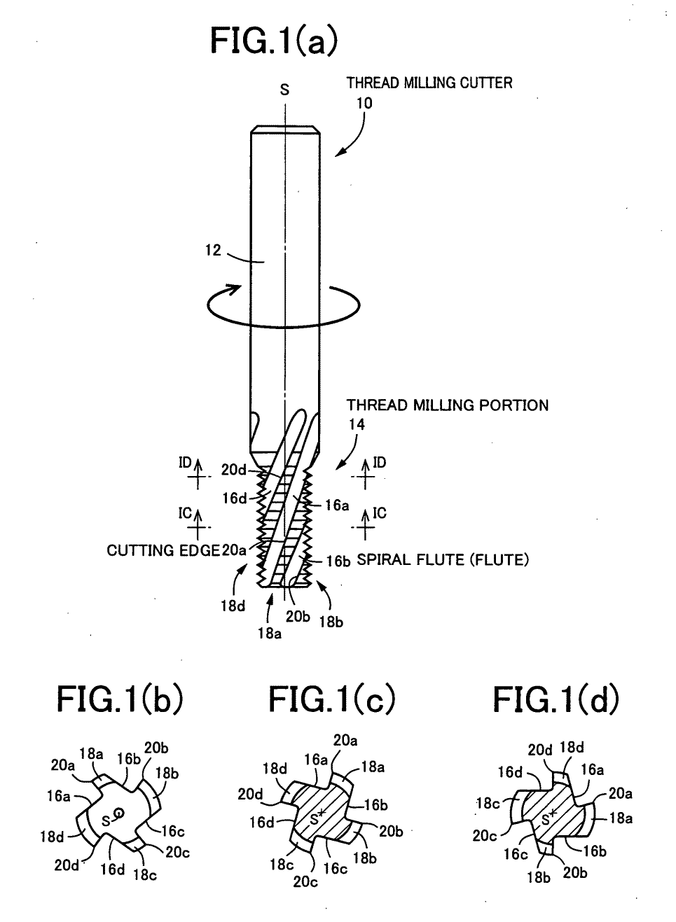

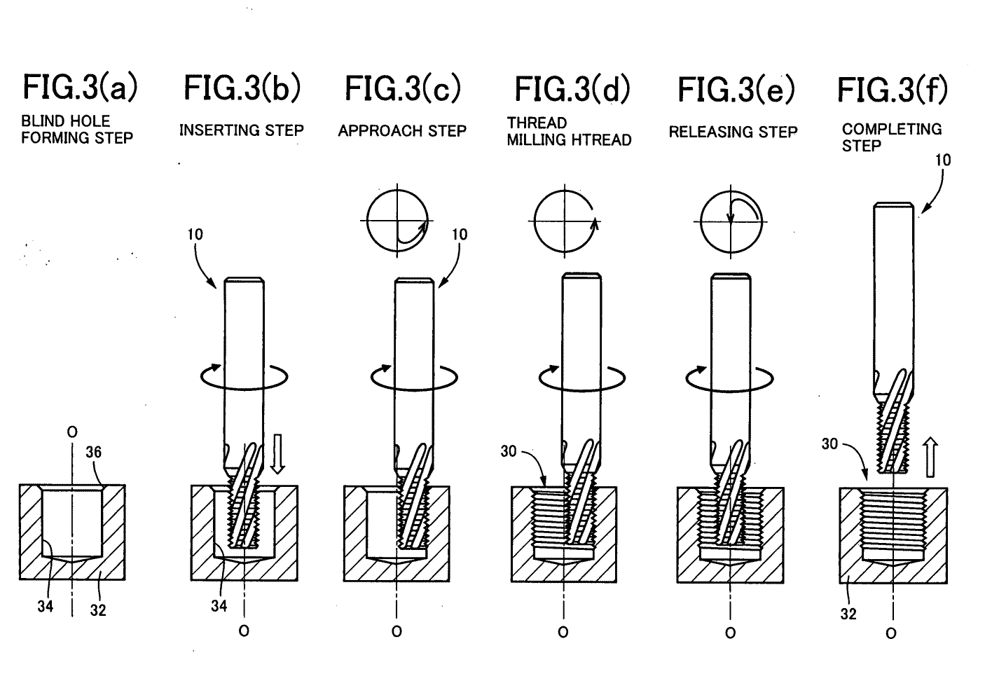

FIGS. 1(a) and 1(b) are views showing a thread milling cutter 10 of one embodiment according to the present invention. FIG. 1(a) is a front view of the thread milling cutter as viewed in a direction perpendicular to a center axis S. FIG. 1(b) is an enlarged bottom view of the thread milling cutter as viewed at a distal end thereof placed in a lower area of FIG. 1(a). FIG. 1(c) is an enlarged cross-sectional view taken on a line IC-IC of FIG. 1(a) and FIG. 1(d) is an enlarged cross-sectional view taken on a line ID-ID of FIG. 1(a). The thread milling cutter 10 includes a shank 12, available to be held with a main spindle of a machining center or the like, and a thread milling portion 14, which are axially formed to be integral with each other. The thread milling portion 14 has an outer circumferential periphery formed with a large number of non-lead convex ridges 20, which have cross-sectional shapes, respectively, each in conformity to a thread groove of a targeted internal thread 30 (see FIG. 3) and axially disposed with the same pitch as that of the internal thread 30. With the provision of four spiral flutes 16a to 16d such that the convex ridges are segmented, the thread milling portion 14 is segmented into four lands 18a to 18d. The four lands 18a to 18d have circumferentially leading faces formed with cutting edges 20a to 20d, respectively, which extend along the spiral flutes 16a to 16d, respectively. With the thread milling cutter 10 of the present embodiment, the thread milling portion 14 has an axial length of approximately 26 mm and a diameter of about 9.5 mm with the convex ridges having a pitch of 1.75 mm. The thread milling cutter 10 is integrally formed of cemented carbide and the thread milling portion 14 has a surface applied with a hard coating film of TiAlN. In FIG. 1(a) conical concaves and convexes in both, right and left, lateral portions of the cutting edges 14, and a large number of transverse lines parallel to each other and perpendicular to the center axis S on the respective lands 18a to 18d corresponding to the concaves and convexes, are the multiple non-lead convex ridges. The four spiral flutes 16a to 16d correspond to the plural flutes formed such that they intersect the convex ridges.

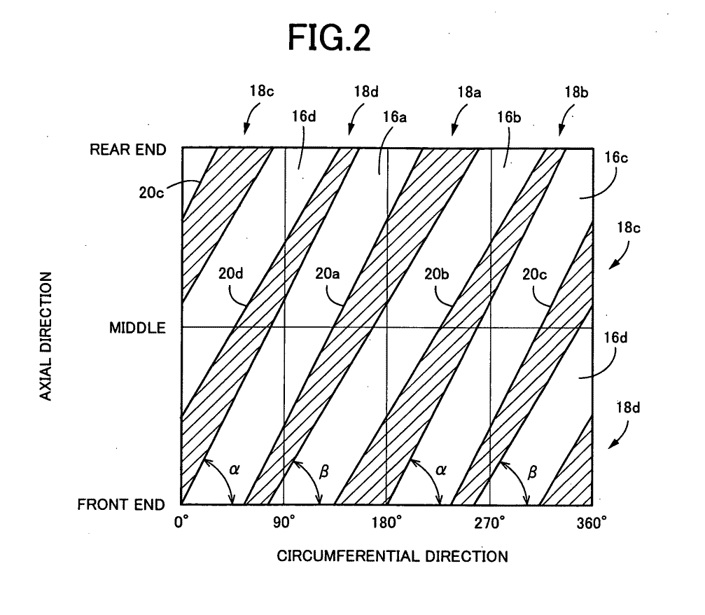

The thread milling cutter 10 is drivably rotated clockwise as viewed from the shank 12 to perform thread-milling operation. To this end, the spiral flutes 16a to 16d are fluted clockwise in the same direction as a thread-milling rotational direction. As will be apparent from a development view of FIG. 2, the spiral flutes 16a to 16d have fixed leads with fixed width dimensions, respectively, with the leads being alternately made different from each other. That is, each of the spiral flutes 16a and 16c has a lead L1 that is greater than a lead L2 of each of the spiral flutes 16b and 16d. The lead L2 falls in a value ranging from 70 to 95% of the lead L1 and is set to lie at a value of approximately 83% of the lead L1 in the illustrated embodiment. In particular, the thread milling cutter 10 has parameters including: the lead L1=60 mm; the lead L2=50 mm; a lead angle α≅63°34′ in each of the spiral flutes 16a and 16c; and a lead angle β≅59°10′ in each of the spiral flutes 16b and 16d. Further, the spiral flutes 16a to 16d are spaced around the center axis S at equal intervals in a central area (a nearly center with the illustrated embodiment) of the thread milling portion 14 in the axial direction thereof with spaces symmetrically varying to smoothly and linearly increase or decrease as the spaces extend toward front and rear ends of the thread milling portion 14. The lands 18a to 18d have land widths (lateral dimensions as viewed in FIG. 2), which are nearly equal at the central area of the thread milling portion 14 in the axial direction thereof. But, the land widths alternately increase or decrease as the lands extend toward the front and rear ends of the thread milling portion 14 in conformity to variations in space among the spiral flutes 16a to 16d. That is, the land widths of the lands 18a and 18c smoothly and linearly increase, respectively, as each land extends from the front end to the rear end of the thread milling portion 14. In contrast, the land widths of the lands 18b and 18d smoothly and linearly decrease, respectively, as each land extends from the front end to the rear end of the thread milling portion 14.

With the spiral flutes 16a to 16d formed with such unequal leads, the cutting edges 20a to 20d, formed along the spiral flutes 16a to 16d around the center axis S, respectively, take unequal leads such that the intervals of the cutting edges 20a to 20d are caused to smoothly and linearly vary in the axial direction. That is, the cutting edges 20a and 20c, formed along the spiral flutes 16a and 16c, respectively, are inclined with the same lead L1 (at a lead angle α) as that of the spiral flutes 16a and 16c. In contrast, the cutting edges 20b and 20d, formed along the spiral flutes 16b and 16d, respectively, are inclined with the same lead L2 (at a lead angle β) as that of the spiral flutes 16b and 16d. Thus, the cutting edges 20a to 20d are spaced at equal intervals in the central area of the thread milling portion 14 in the axial direction thereof with the intervals smoothly and linearly increasing and decreasing in symmetric fashion as the cutting edges extend toward the front and rear ends of the thread milling portion 14. This results in an increase in an unequal percentage of the unequal intervals, i.e., a dimensional ratio between an area with a narrowed interval and the other area with a widened interval. More particularly, the interval between the cutting edges 20a and 20b and the interval between the cutting edges 20c and 20d are caused to smoothly and linearly increase as the cutting edges extend from the frond end to the rear end of the thread milling portion 14. On the contrary, the interval between the cutting edges 20b and 20c and the interval between the cutting edges 20d and 20a are caused to smoothly and linearly decrease as the cutting edges extend from the frond end to the rear end of the thread milling portion 14. Thus, the cutting edges are spaced at the equal intervals in the central area of the thread milling portion 14 in the axial direction thereof. In contrast, the cutting edges are spaced at the unequal intervals as the cutting edges are dislocated from the central area toward the frond and rear ends of the thread milling portion 14 with the unequal interval varying at an unequal percentage that linearly increases as the cutting edges extend toward the frond and rear ends of the thread milling portion 14. In the illustrated embodiment, the central area, in which the cutting edges 20a to 20d are spaced at the equal intervals, will be referred to as a “predetermined intermediate position”.

In milling the internal thread 30 with the use of such a thread milling cutter 10, first, a blind hole 34 is formed in a workpiece 32 made of thread raw material to be formed with the targeted internal thread 30 as shown in FIG. 3(a). The blind hole 34 is made larger in diameter than the thread milling portion 14 to be equal to or slightly smaller than a minor diameter of the internal thread 30. A chamfered portion 36 is formed at an entrance opening (opening portion) of the blind hole 34 with a tapered shape depending on needs. FIG. 3 shows a process in sequence of threading the internal thread 30 with the blind hole 34 having a bottomed end.

As shown in FIG. 3(b), subsequently, the thread milling cutter 10, attached to a spindle of a three-dimensional machine tool such as a machining center or the like, is then introduced into the blind hole 34 along a centerline O thereof. Then, as shown in FIG. 3(c), the thread milling cutter 10 is drivably rotated about its center axis and caused to smoothly bite into an inner circumferential wall of the blind hole 34 in an approach range of approximately 90°. Under such a state, as shown in FIG. 3(d), the thread milling cutter 10 is drivably rotated about its center axis S to trace about the centerline O of the blind hole 34 in orbital movement by an angle of 360°, after which the thread milling cutter 10 is axially lead fed by a distance corresponding to one pitch P of the convex ridges to mill the targeted internal thread 30. In the illustrated embodiment, the thread milling cutter 10 is rotated counterclockwise in orbital movement and retracted toward the shank 12 by a distance corresponding to one pitch P, upon which the internal thread 30 is milled in a right-hand thread. In this moment, the internal thread 30 is cut such that the central area of the thread milling portion 14, in which the cutting edges 20a to 20d are spaced at the equal intervals, is involved to be located at a nearly central area of the internal thread 30 in an axial direction thereof. Thereafter, as shown in FIG. 3(e), the thread milling cutter 10 is smoothly released from the inner circumferential wall of the blind hole 34 within a release range of 90° for recovery to the centerline O of the blind hole 34. Subsequently, as shown in FIG. 3(f), the thread milling cutter 10 is pulled out of the blind hole 34 along the centerline O thereof to complete a series of thread-cutting operations.

With the thread milling cutter 10 of the present embodiment, the plural cutting edges 20a to 20d are formed with the fixed lead L1 (at the lead angle α) or the fixed lead L2 (at the lead angle β). The lead L1 of the cutting edges 20a and 20c are made different form the lead L2 of the cutting edges 20b and 20d adjacently placed circumferentially S. The intervals of the cutting edges 20a to 20d are caused to in series vary in the axial direction, so that the intervals, associated with the cutting edges 20a to 20d, remain unequal. This allows a thread (such as the internal thread 30 or the like) to be milled with milling resistance varying in irregular increase or decrease, thereby suppressing the occurrence of chatter vibration. Thus, the thread can be cut with excellent milling precision under various milling conditions.

Further, the plural cutting edges 20a to 20d are spaced at the equal intervals in the central area of the thread milling portion 14 in the axial direction thereof, whereas in the other areas deviated from the central area to be closer to the front and rear ends of the thread milling portion 14, the cutting edges 20a to 20d are spaced at the unequal intervals. This enables the thread (such as the internal thread 30 or the like) to be milled with a vicinity of the central area being involved. This alleviates unbalanced load that would act on the thread milling portion 14 at fore and aft parts of the central area in the axial direction, thereby making it possible to stably mill the thread with a center on the central area. Combined with the unequal intervals of the cutting edges 20a to 20d formed on both sides of the central area, chatter vibration can be further effectively suppressed and, therefore, the thread can be milled with excellent milling precision under various milling conditions.

In the illustrated embodiment, further, the plural cutting edges 20a to 20d are formed with the fixed lead L1 (at the lead angle α) or the fixed lead L2 (at the lead angle β) with the lead L1 of the cutting edges 20a and 20c being made different from the lead L2 of the neighboring cutting edges 20b and 20d present around the center axis S. This allows the cutting edges 20a to 20d to have the intervals that symmetrically increase or decrease as the intervals extend from the central area toward the front and rear ends of the thread milling portion 14. Thus, the thread can be further stably milled with a center on the central area. In addition, with the cutting edges 20a to 20d having the leads L1 and L2 both of which are fixed, the cutting edges 20a to 20d can be easily formed with increased precision.

In the illustrated embodiment, furthermore, all of the plural flutes 20a to 20d are formed with the fixed width dimensions and the fixed lead L1 (at the lead angle α) or the fixed lead L2 (at the lead angle β). In addition, the lead L1 of the spiral flutes 16a and 16c is made different from the lead L2 of the spiral flutes 16b and 16d. This allows the cutting edges 20a and 20c to be formed along the spiral flutes 16a and 16c with the lead L1, which is made different from the lead L2 of the cutting edges 20b and 20d adjacently placed around the center axis S. When lead feeding a tool raw material for grinding, for instance, the spiral flutes 16a to 16d, merely varying the leads of the spiral flutes 16a to 16d, upon varying a rotational speed or a feed speed, enables the cutting edges 20a to 20d to be easily formed with predetermined leads L1 and L2 with high precision at low cost.

In the illustrated embodiment, moreover, the four cutting edges 20a to 20d include even numbers of cutting edges that are alternately formed with the lead L1 (at the lead angle α) and the lead L2 (at the lead angle β) of two kinds different from each other. This effectively suppresses the occurrence of chatter vibration due to cyclic change of milling resistance in a greater effect than that achieved when merely varying any one of the leads of the four cutting edges 20a to 20d.

In the illustrated embodiment, furthermore, the plural cutting edges 20a to 20d are provided with the two kinds of leads including the leads L1 and L2. The smaller lead L2 is set to lies in a value ranging from 0.7×L1 to 0.95×L1 to be less than 95% of the lead L1. This allows the unequal intervals of the cutting edges 20a to 20d, resulting from a difference in leads, to have a stable effect of suppressing the occurrence of chatter vibration. With the lead L2 having a value greater than 70% of the lead L1, moreover, it becomes possible for the thread milling portion 14 to ensure a predetermined axial length for milling the thread without causing the adjacent cutting edges not to intersect each other on the thread milling cutter 10 having the four cutting edges.

In the illustrated embodiment, besides, the plural cutting edges 20a to 20d are spaced at the equal intervals in the central area of the thread milling portion 14 along the axial direction thereof. In general practice, the thread can be milled with the central area of the thread milling portion 14 being involved. Therefore, it becomes possible to have a stable effect of suppressing the occurrences of unbalanced load and chatter vibration with improved milling precision without making a conscious determination to prepare a particular area for the thread milling portion 14 to be involved for the cutting.

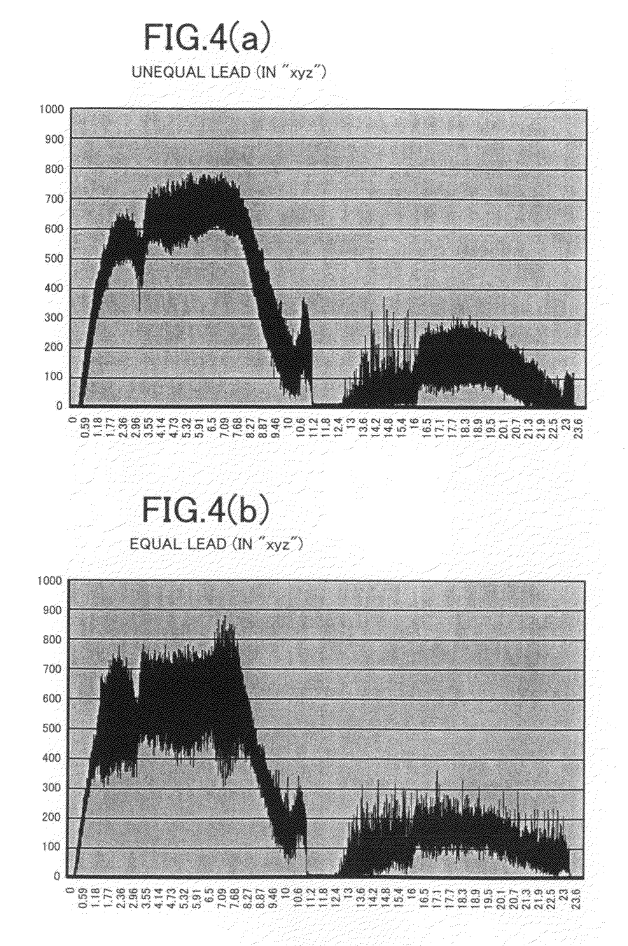

In this connection, tests were conducted to cut internal threads under milling conditions described below upon using the thread milling cutter 10 of the present embodiment and a comparative product. With the comparative product, all of the spiral flutes 16a to 16d had the lead L2. That is, the cutting edges 20a to 20d had the lead L2 (=50 mm) at the lead angle of β(≅59° 10′) and were spaced at the equal intervals circumferentially S. Upon measuring milling resistances (N) oriented in the xyz-direction for comparison, results were obtained as shown in FIGS. 4 to 7. Milling resistance, occurring in the xy-direction, represents a rotational load oriented in a direction perpendicular to the center axis S, i.e., circumferentially S, and a load caused in orbital movement, and the z-direction represents a load oriented in the axial direction. Among the milling conditions, further, “Zero-Cut with One Revolution” represents step to be performed when further increased precision is required, including step of repeatedly executing the same operation (in rotation and orbit) as that of milling the thread with a zeroed cutting depth.
(Milling conditions)
Workpiece Material: SCM440 (40HRC)
Cutting Speed V: 50 m/min
Feed Speed “f′ per One Cutting Edge: 0.05 mm/t
Diameter of Internal Thread to be cut: M12×1.75 (with Dead-End Hole)
Tapping Length: Approximately 20 mm
Cutting Oil: Water Soluble Cutting Fluid
Thread Pattern: Cut With One Orbit+Zero-Cut With One Orbit
Used machine: Vertical Machining Center

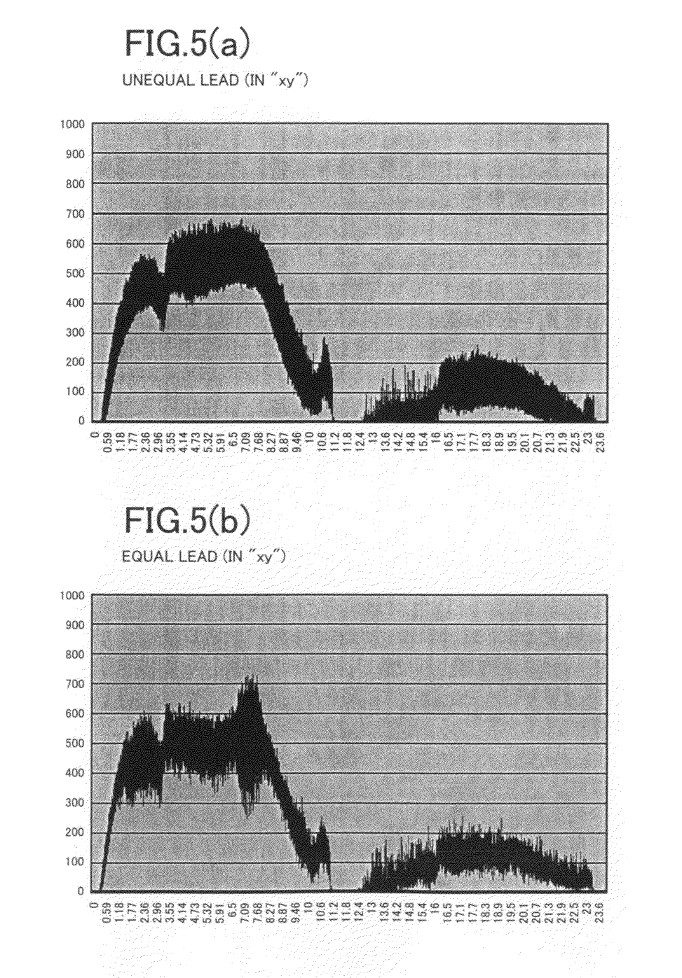

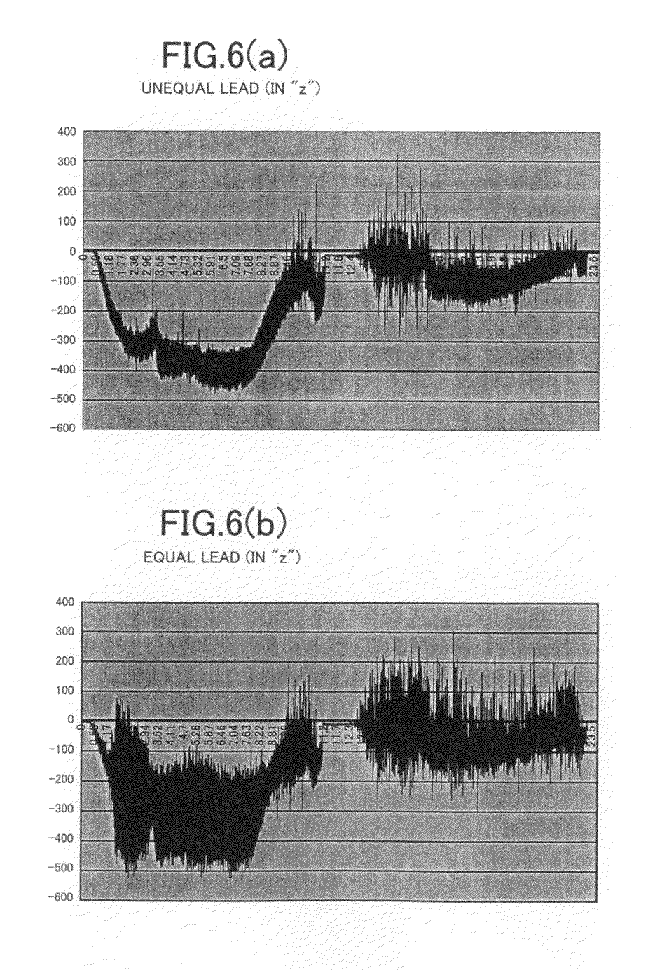

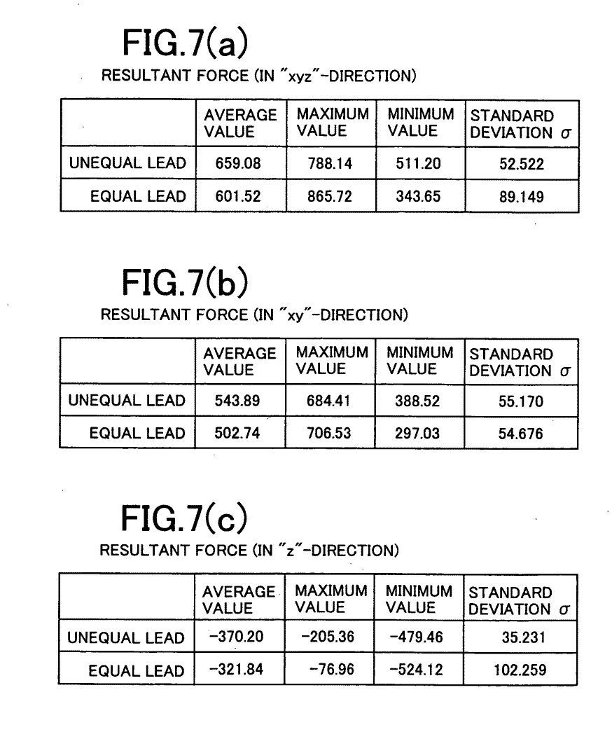

In FIGS. 4 to 7, the unequal leads represent results obtained by the inventive product and the equal leads represent results obtained by the comparative product. In graphs of FIGS. 4 to 6, a vertical axis represents milling resistance (N) and a horizontal axis represents time (in second) with one orbit being accomplished in about ten seconds. Further, FIGS. 4(a) and 4(b) represent graphs showing variations in resultant forces of milling resistances in the xyz-direction; FIGS. 5(a) and 5(b) represent graphs showing variations in resultant forces of milling resistances in the xy-direction; FIGS. 6(a) and 6(b) represent graphs showing variations in milling resistances in the z-direction; and FIGS. 7(a) to 7(c) represent results obtained by calculating an average value, a maximum value, a minimum value and a standard deviation a based on data related to these milling resistances. As will be clear from the graphs of FIGS. 4 and 6 and calculation values of FIGS. 7(a) and 7(c), it will be understood that the inventive product (with the unequal leads) has less fluctuations in range and standard deviation a in milling resistance than those of the comparative product (with the equal leads) with resultant remarkable suppression of chatter vibration. No significant difference is present between the inventive product and the comparative product in respect of the graphs and the calculation values related to milling resistance in the xy-direction shown in FIGS. 5 and FIG. 7(b). Thus, it can be considered that vibration, caused by milling resistance in the z-direction (in the axial direction), is remarkably improved.

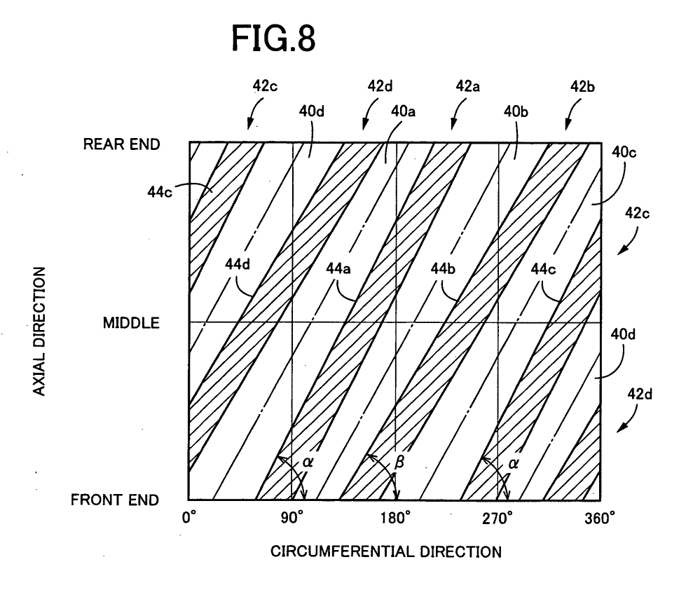

In the illustrated embodiment described above, moreover, the spiral flutes 16a to 16d are formed with two kinds of leads L1 and L2 in the fixed width dimensions such that the plural cutting edges 20a to 20d are formed with the unequal leads. As shown in FIG. 8, a plurality of spiral flutes 40a to 40d may be formed with fixed leads that are equal to each other. The spiral flutes 40a and 40c extend from the front end to the rear end of the thread milling portion with linearly decreasing width dimensions. The remaining spiral flutes 40b and 40d extend from the front end to the rear end with linearly increasing width dimensions. This enables cutting edges 44a to 44d to be formed along the spiral flutes 40a to 40d with unequal leads. Thus, the cutting edges 44a to 44d can be located circumferentially S at intervals that smoothly and linearly vary in an axial direction. In FIG. 8, single-dot lines indicate centerlines of the spiral flutes 40a to 40d, respectively, which extend in parallel to each other, i.e., with equal leads. The spiral flutes 40a to 40d have width dimensions that symmetrically increases or decreases with respect to the respective centerlines. In addition, the spiral flutes 40a and 40c and the spiral flutes 40b and 40d have the width dimensions that symmetrically increase or decrease in the axial direction of the thread milling portion 14 across the central area thereof. This allows the spiral flutes 40a to 40d to be formed with four lands 42a to 42d having land widths nearly equal to each other and nearly kept constant throughout the lengths of the lands in the axial direction.

The cutting edges 44a and 44c, formed along the spiral flutes 40a and 40c, respectively, are inclined with the same lead L1 (at the lead angle α) as that of the cutting edges 20a and 20c. The cutting edges 44b and 44d, formed along the spiral flutes 40b and 40d, respectively, are inclined with the same lead L2 (at the lead angle β) as that of the cutting edges 20b and 20d. In addition, the cutting edges 44a to 44d are spaced circumferentially S at equal intervals in the central area of the thread milling portion 14 along the axial direction thereof. These intervals smoothly and linearly increase or decrease in symmetric fashions with the unequal intervals varying at an increasing unequal percentage to obtain the same advantageous effects as those of the previous embodiment.

In this case, further, the spiral flutes 40a and 40c have the width dimensions that decrease from the front end to the rear end of the thread milling portion. Likewise, the spiral flutes 40b and 40d have the width dimensions that increase from the front end to the rear end. This allows the cutting edges 44a and 44c to have the lead L1 made different from the lead L2 of the cutting edges 44b and 44d. Thus, by merely varying an attitude of, for instance, a grinding wheel to grind the spiral flutes 40a to 40d to vary the width dimensions of the spiral flutes 40a to 40d, the cutting edges 44a to 44d can be easily formed with the predetermined leads L1 and L2 with high precision at low cost.

While the present invention has been described above with reference to the illustrated embodiments shown in the drawings, it is intended that the present invention described be considered only as illustrative of one embodiment and that the present invention may be implemented in various modifications and improvements based on knowledge of those skilled in the art.

### INDUSTRIAL APPLICABILITY OF INVENTION

The thread milling cutter according to the present invention has the plural cutting edges with the leads at least one of which is made different from the lead of the adjacent cutting edge. This allows the cutting edges to be formed circumferentially at the unequal intervals with resultant milling resistance varying in irregular increase or decrease during operation to mill the thread. This suppresses the occurrence of chatter vibration due to resonance and allows favorable application to work of milling a thread with high precision under various milling conditions.

1. A thread milling cutter having an outer circumferential periphery, formed with multiple non-lead convex ridges, which have cross-sectional shapes, respectively, each in conformity to a thread groove of a targeted internal thread, with a fixed pitch in an axial direction of the thread milling cutter, and plural flutes intersecting with the convex ridges to define plural segmented lands circumferentially formed with plural cutting edges facing the flutes, respectively, wherein:
the plural cutting edges spirally extend in a same direction circumferentially or extend in parallel to the center axis, and have fixed leads, respectively, in which the lead of at least one of the cutting edges is made different from the lead of another cutting edge adjacently placed circumferentially such that the cutting edges are spaced circumferentially at intervals that in series vary in an axial direction.

2. A thread milling cutter having an outer circumferential periphery, formed with multiple non-lead convex ridges, which have cross-sectional shapes, respectively, each in conformity to a thread groove of a targeted internal thread, with a fixed pitch in an axial direction of the thread milling cutter, and plural flutes intersecting with the convex ridges to define plural segmented lands circumferentially formed with plural cutting edges facing the flutes, respectively, wherein:
the plural cutting edges spirally extend in a same direction circumferentially or extend in parallel to the center axis, and have equal intervals circumferentially in a predetermined intermediate position of a thread milling portion, formed with the plural cutting edges, along an axial direction thereof, but have unequal intervals in other areas deviated from the intermediate position toward front and rear ends of the thread milling portion.

3. The thread milling cutter according to claim 2, wherein the plural cutting edges have fixed leads, respectively, in which the lead of at least one of the cutting edges is made different from the lead of another cutting edge neighboring circumferentially to allow the cutting edges to have intervals circumferentially that symmetrically with respect to a centerline of the spiral flute and smoothly increase or decrease as the cutting edges extend from the intermediate position toward a front end and a rear end of the thread milling portion.

4. The thread milling cutter according to claim 3, wherein the plural flutes have fixed width dimensions with fixed leads, respectively, in which the lead of at least one of the plural flutes is made different from the lead of another plural flute adjacently placed circumferentially such that the lead of one cutting edge formed facing the one flute, is made different from the lead of the another cutting edge adjacently placed circumferentially.

5. The thread milling cutter according to claim 3, wherein the plural flutes are formed with fixed leads equal to each other in which at least one of the plural flutes has a width dimension that linearly increases or decreases such that the lead of one cutting edge formed facing the one flute, is made different from the lead of another cutting edge adjacently placed circumferentially.

6. The thread milling cutter according to claim 1, wherein the plural cutting edges include even numbers of cutting edges that are alternately formed with two different kinds of leads.

7. The thread milling cutter according to claim 1, wherein the plural cutting edges are formed with two kinds of leads including L1 and L2, in which the smaller lead L2 is set to lie in a value ranging from 0.7×L1 to 0.95×L1.

8. The thread milling cutter according to claim 1, wherein the plural cutting edges are spaced circumferentially at equal intervals in a central area, in which the plural cutting edges are formed, of the thread milling portion in the axial direction thereof.
